(19) United States
(12) Patent Application Publication
(10) Pub. No.: US 2022/0343712 A1
(43) Pub. Date: Oct. 27, 2022

(54) NUMBER OF PEOPLE ESTIMATION DEVICE, NUMBER OF PEOPLE ESTIMATION METHOD, AND NUMBER OF PEOPLE ESTIMATION PROGRAM

(71) Applicant: NIPPON TELEGRAPH AND TELEPHONE CORPORATION, Tokyo (JP)

(72) Inventors: Maiko NAYA, Tokyo (JP); Akira NAKAYAMA, Tokyo (JP); Shinya OI, Tokyo (JP); Yusuke TANAKA, Tokyo (JP); Masaru MIYAMOTO, Tokyo (JP)

(73) Assignee: NIPPON TELEGRAPH AND TELEPHONE CORPORATION, Tokyo (JP)

(21) Appl. No.: 17/636,860

(22) PCT Filed: Aug. 22, 2019
(86) PCT No.: PCT/JP2019/032853

§ 371 Date: Feb. 19, 2022

(51) Int. Cl. G07C 9/30

(52) U.S. Cl. CPC G07C 9/30

(57) ABSTRACT

A people count estimation apparatus includes an information management unit configured to at least manage road network data which is spatial information data regarding a road network formed to include a plurality of observation points and a road connecting the observation points, an observation point list which is a list of the observation points, and the numbers of people passing per unit time at the observation points in each direction of the road, a coefficient calculation unit configured to identify, from the observation point list, a first observation point where the number of people passing in each direction is not measured among the plurality of observation points, identify a second observation point where the number of people passing in each direction is measurable and which is connected to the first observation point by the road among the plurality of observation points, and calculate a weight that an observation value per time period at the second observation point contributes to the number of people passing in each direction at the first observation point, and an estimation unit configured to estimate the number of people passing in each direction at the first observation point using the weight, the observation value at the second observation point, and data regarding a people count observed at the first observation point.

### TECHNICAL FIELD

The disclosed technology relates to a people count estimation apparatus, a people count estimation method, and a people count estimation program.

### BACKGROUND ART

A large number of visitors crowd at or around a venue of large-scale events such as concerts, sports competitions, and fireworks displays where a large number of visitors are expected. A multi-agent simulator (MAS) that simulates the movement behavior of a large number of people is often used to grasp the congestion situation and examine a control plan for congestion. To accurately reproduce human movements with a multi-agent simulator, it is desirable to use actually measured observation data.

Techniques for simulating an overall flow of people using observation data include route-specific people count estimation methods that estimate the number of people who have selected respective routes (for example, NPL 1 and 2). In these methods, it is assumed that observation data is acquired using manual measurement of counting the number of people passing in each direction of movement as an observation method or using a camera that can identify the direction of walking and count the number of people or a camera that only counts the number of people.

### CITATION LIST

### Non Patent Literature

NPL 1: Hitoshi Shimizu, Tatsufumi Matsubayashi, Yusuke Tanaka, Tomoharu Iwata, Hiroshi Sawada, “Estimation of the number of people on each route considering the number of people in attendance,” 2018 (32nd) Annual Conference of the Japanese Society for Artificial Intelligence, 2018

NPL 2: Hiroshi Kiyotake, Masahiro Kojima, Tatsufumi Matsubayashi, Hiroyuki Toda, “Estimation of the number of people passing on each route considering time delay,” 2018 (32nd) Annual Conference of the Japanese Society for Artificial Intelligence, 2018

### SUMMARY OF THE INVENTION

### Technical Problem

In the method of estimating the number of people moving, it is considered that the larger the number of observation points that measure the number of people, the closer to reality the simulation can be performed. On the other hand, if a large number of observation devices for measuring the number of people are installed to improve the accuracy of estimation, the cost increases as the number of installed devices increases.

The disclosed technology has been made in view of the above points and it is an object of the disclosed technology to provide a people count estimation apparatus, a people count estimation method, and a people count estimation program that can estimate the number of people with high accuracy while reducing the installation cost of observation devices.

### Means for Solving the Problem

A first aspect of the disclosed technology is a people count estimation apparatus including an information management unit configured to at least manage road network data which is spatial information data regarding a road network formed to include a plurality of observation points and a road connecting the observation points, an observation point list which is a list of the observation points, and the numbers of people passing per unit time at the observation points in each direction of the road, a coefficient calculation unit configured to identify, from the observation point list, a first observation point where the number of people passing in each direction is not measured among the plurality of observation points, identify a second observation point where the number of people passing in each direction is measurable and which is connected to the first observation point by the road among the plurality of observation points, and calculate a weight that an observation value per time period at the second observation point contributes to the number of people passing in each direction at the first observation point, and an estimation unit configured to estimate the number of people passing in each direction at the first observation point using the weight, the observation value at the second observation point, and data regarding a people count observed at the first observation point.

A second aspect of the disclosed technology is a people count estimation method for a computer executing processing including at least managing road network data which is spatial information data regarding a road network formed to include a plurality of observation points and a road connecting the observation points, an observation point list which is a list of the observation points, and the numbers of people passing per unit time at the observation points in each direction of the road, identifying, from the observation point list, a first observation point where the number of people passing in each direction is not measured among the plurality of observation points, identifying a second observation point where the number of people passing in each direction is measurable and which is connected to the first observation point by the road among the plurality of observation points, and calculating a weight that an observation value per time period at the second observation point contributes to the number of people passing in each direction at the first observation point, and estimating the number of people passing in each direction at the first observation point using the weight, the observation value at the second observation point, and data regarding a people count observed at the first observation point.

A third aspect of the disclosed technology is a people count estimation program causing a computer to execute processing including at least managing road network data which is spatial information data regarding a road network formed to include a plurality of observation points and a road connecting the observation points, an observation point list which is a list of the observation points, and the numbers of people passing per unit time at the observation points in each direction of the road, identifying, from the observation point list, a first observation point where the number of people passing in each direction is not measured among the plurality of observation points, identifying a second observation point where the number of people passing in each direction is measurable and which is connected to the first observation point by the road among the plurality of observation points, and calculating a weight that an observation value per time period at the second observation point contributes to the number of people passing in each direction at the first observation point, and estimating the number of people passing in each direction at the first observation point using the weight, the observation value at the second observation point, and data regarding a people count observed at the first observation point.

### Effects of the Invention

According to the disclosed technology, it is possible to estimate the number of people with high accuracy while reducing the installation cost of observation devices by using known measurement values measured at observation points where the number of people passing in each direction can be measured and observation data relating to the number of people measured at the observation point where the number of people passing in each direction is to be estimated.

### BRIEF DESCRIPTION OF DRAWINGS

FIG. 1 is a block diagram illustrating a hardware configuration of a people count estimation apparatus according to the present embodiment.

FIG. 2 is a block diagram illustrating an example of a functional configuration of a people count estimation apparatus according to the present embodiment.

FIG. 3 is a flowchart showing an exemplary operation of the people count estimation apparatus according to the present embodiment.

FIG. 4 is a diagram illustrating an example of road network data.

FIG. 5 is a diagram for explaining weight data of a vehicle.

FIG. 6 is a diagram for explaining weight data of the vehicle.

FIG. 7 is a diagram for explaining calculation of weights.

### DESCRIPTION OF EMBODIMENTS

Hereinafter, an example of an embodiment of the disclosed technology will be described with reference to the drawings. The same or equivalent components and parts are denoted by the same reference signs in each drawing. The dimensional ratios in the drawings are exaggerated for convenience of explanation and may differ from the actual ratios.

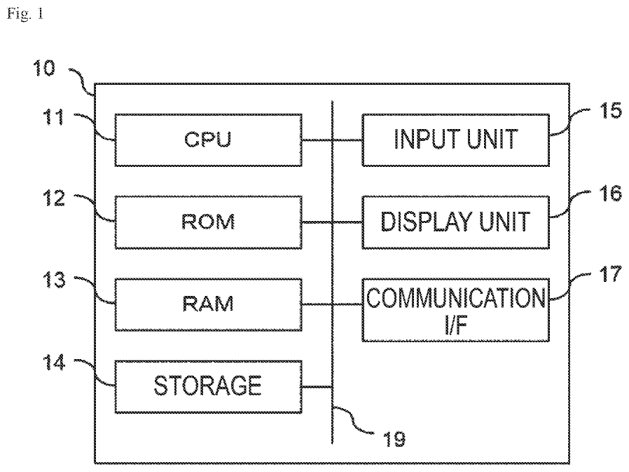

FIG. 1 is a block diagram illustrating a hardware configuration of a people count estimation apparatus 10. The people count estimation apparatus 10 is an apparatus that estimates the number of people passing through an observation point where the number of people passing in each direction is to be estimated using known measurement values measured at observation points where the number of people passing in each direction can be measured and observation data relating to the number of people measured at the observation point where the number of people passing in each direction is to be estimated.

As illustrated in FIG. 1, the people count estimation apparatus 10 includes a central processing unit (CPU) 11, a read only memory (ROM) 12, a random access memory (RAM) 13, a storage 14, an input unit 15, a display unit 16, and a communication interface (I/F) 17. These components are communicatively connected to each other via a bus 19.

The CPU 11 is a central arithmetic processing unit and executes various programs and controls each part. That is, the CPU 11 reads a program from the ROM 12 or the storage 14 and executes the program using the RAM 13 as a work area. The CPU 11 controls each of the components described above and performs various arithmetic processing according to programs stored in the ROM 12 or the storage 14. In the present embodiment, the ROM 12 or the storage 14 stores a people count estimation program that estimates the number of people passing in each direction at an observation point where the number of people is not measured.

The ROM 12 stores various programs and various data. The RAM 13 temporarily stores a program or data as a work area. The storage 14 includes a hard disk drive (HDD) or a solid state drive (SSD) and stores various programs including an operating system and various data.

The input unit 15 includes a pointing device such as a mouse and a keyboard and is used to perform various inputs.

The display unit 16 is, for example, a liquid crystal display and displays various types of information. The display unit 16 may adopt a touch panel method and function as an input unit 15.

The communication interface 17 is an interface for communicating with other devices and uses standards such as, for example, Ethernet (registered trademark), FDDI, and Wi-Fi (registered trademark).

Next, a functional configuration of the people count estimation apparatus 10 will be described.

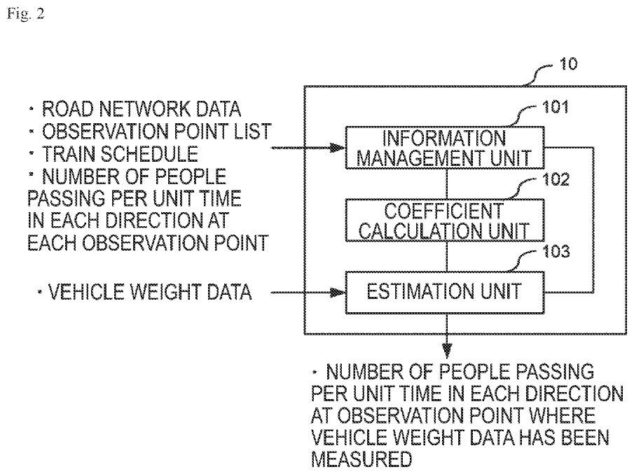

FIG. 2 is a block diagram illustrating an example of the functional configuration of the people count estimation apparatus 10.

As illustrated in FIG. 2, the people count estimation apparatus 10 includes an information management unit 101, a coefficient calculation unit 102, and an estimation unit 103 as functional components. Each functional component is realized by the CPU 11 reading the people count estimation program stored in the ROM 12 or the storage 14 and loading and executing the people count estimation program into and from the RAM 13.

The information management unit 101 at least manages road network data which is spatial information data regarding a road network formed to include observation points and roads connecting the observation points, an observation point list which is a list of observation points, and the numbers of people passing per unit time at the observation points in each direction of the roads. In the road network data, roads can be represented as lines connecting observation points. It is assumed that humans move on the roads between observation points. The observation point list which is a list of observation points may include information on whether or not the number of people is measured at each observation point. The observation point list may also include information on whether or not each observation point can measure the number of people passing in each direction.

The coefficient calculation unit 102 identities, from the information management unit 101, the road network data and a first observation point where the number of people passing in each direction is not measured among the observation points. Here, each direction refers to each direction of human movement. The coefficient calculation unit 102 identifies second observation points, which are connected to the first observation point by roads and where the number of people passing in each direction can be measured, from the observation points. Then, the coefficient calculation unit 102 calculates weights λ which are the contributions of observation values in time periods of the second observation points to the first observation point where the number of people passing in each direction is to be estimated. A method of calculating the weights λ by the coefficient calculation unit 102 will be described later.

The estimation unit 103 uses the weights λ calculated by the coefficient calculation unit 102, the observation values at the second observation points, and data regarding a people count observed at the first observation point where the number of people is not measured to estimate the number of people passing in each direction at the first observation point. An example of the data regarding the people count is weight data of a vehicle on which people ride, the weight data being measured every unit time. The vehicle can be, for example, a vehicle of a train. In the present embodiment, an example of estimating the number of people passing in each direction using weight data of a vehicle of a train will be described. It is assumed that the weight of a vehicle of a train is measured when the train arrives at a platform and when the train departs from the platform.

The estimation unit 103 sends, to the information management unit 101, a result of estimation of the number of people passing in each direction at the first observation point where the number of people passing in each direction has been estimated. The information management unit 101 determines the consistency of the result of the estimation of the number of people passing in each direction at the first observation point sent from the estimation unit 103.

Specifically, the information management unit 101 determines the consistency based on whether or not an estimation value of the number of people passing in each direction at the first observation point deviates from observation values of the number of people passing in each direction at second observation points in the vicinity which are connected to the first observation point by roads. Upon determining that the estimated number of passing people is consistent, the information management unit 101 determines that the estimation result of the estimation unit 103 is reliable. If the estimation result of the estimation unit 103 is reliable, the estimation unit 103 may cause the display unit 16 to display the estimation result or may transmit the estimation result to another device through the communication interface 17. On the other hand, upon determining that the estimated number of passing people is inconsistent, the information management unit 101 causes the coefficient calculation unit 102 to recalculate the weights λ.

Next, an operation of the people count estimation apparatus 10 will be described.

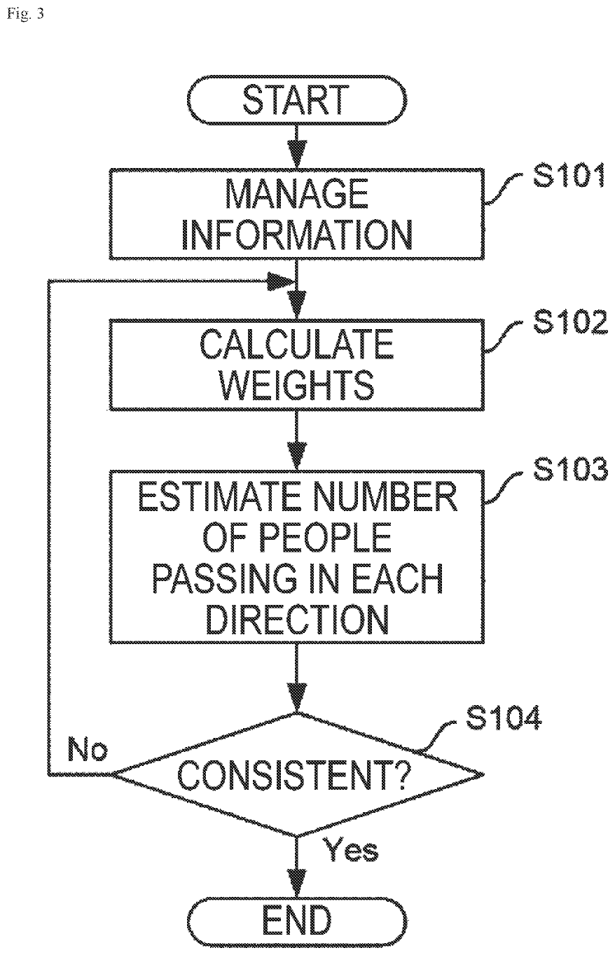

FIG. 3 is a flowchart showing an exemplary operation of the people count estimation apparatus 10.

The CPU 11 manages road network data that is spatial information data regarding a road network that is a network of roads between observation points, an observation point list that is a list of observation points, and the numbers of people passing per unit time at observation points in each direction of roads (step S101).

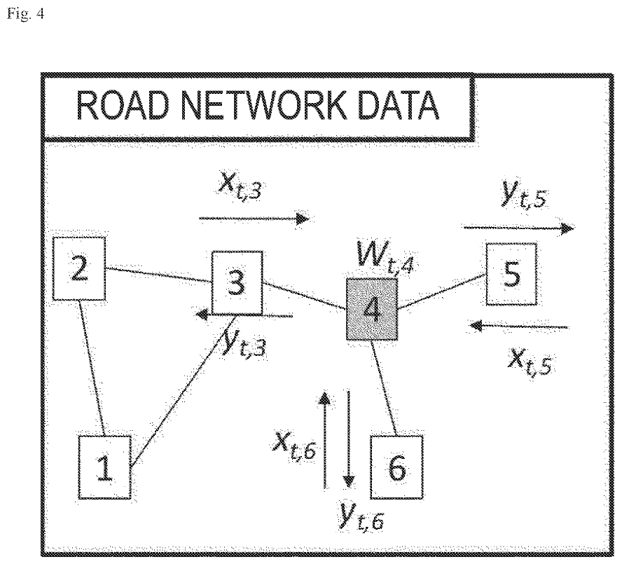

FIG. 4 is a diagram illustrating an example of road network data managed by the information management unit 101. In FIG. 4, an observation point 4 is assumed to be a point such as a stop point, like a platform of a station, where a vehicle of a train stops. At the observation point 4, the number of people passing in each direction is unknown and the number of people is not directly measured, but data regarding a people count can be measured. Observation points 3, 5 and 6 are assumed to be observation points such as gatelines of a station where the number of people passing per unit time in each direction can be known. The observation point 4 is connected to the observation points 3, 5 and 6 by roads.

In the following description, the direction in which people pass through a gateline and get on a train is referred to as an X direction and the direction in which people get off a train and exit a gateline is referred to as a Y direction.

Here, the meanings of variables handled when describing the operation of the people count estimation apparatus 10 will be described. In the following description and mathematical expressions, a symbol consisting of a letter (for example, X) with “^{—}” above it may be represented as ^{—}X or the like below. Also, in the mathematical expressions, a symbol consisting of a letter (for example, X) with “\hat{ }” above it may be represented as \hat{ }X below.

t indicates time, T indicates the maximum time it takes for a person to walk through the road network. m indicates an observation point for observing the number of passing people. x_{t,m} indicates an actually measured observation value (number of people/unit time) of the number of people passing in the X direction at time t at an observation point m. y_{t,m} indicates an actually measured observation value (number of people/unit time) of the number of people passing in the Y direction at time t at an observation point m. X_{t,m} indicates an estimation value (number of people/unit time) of the number of people passing in the X direction at time t at an observation point m. Y_{t,m} indicates an estimation value (number of people/unit time) of the number of people passing in the Y direction at time t at an observation point m. Wₜ indicates weight data of a vehicle at time t. λ_{t,m} indicates a coefficient by which the number of people passing in the X direction at time t at an observation point m is multiplied. \hat{ }λ_{t,m} indicates a coefficient by which the number of people passing in the Y direction at time t at an observation point m is multiplied.

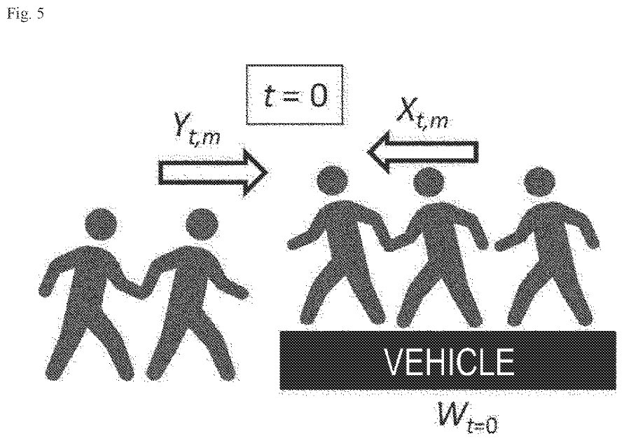

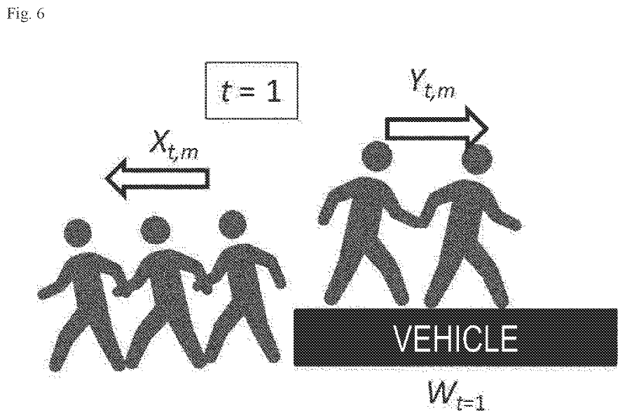

FIGS. 5 and 6 are diagrams for explaining weight data of a vehicle. FIG. 5 is a diagram for explaining weight data W₀ at time t=0. FIG. 6 is a diagram for explaining weight data W₁ at time t=1. The people count estimation apparatus 10 calculates estimation values X_{t,m} and Y_{t,m} of the number of passing people using a change between the weight data W₀ and W₁.

Subsequent to step S101, the CPU 11 acquires the managed road network data and a first observation point where the number of people is not measured among the observation points. Then, the CPU 11 identifies second observation points, where the number of people passing in each direction can be measured and which are connected to the first observation point by roads, from the observation points. The CPU 11 calculates weights λ which are the contributions of observation values in time periods of the second observation points to the first observation point where the number of people passing in each direction is to be estimated (step S102).

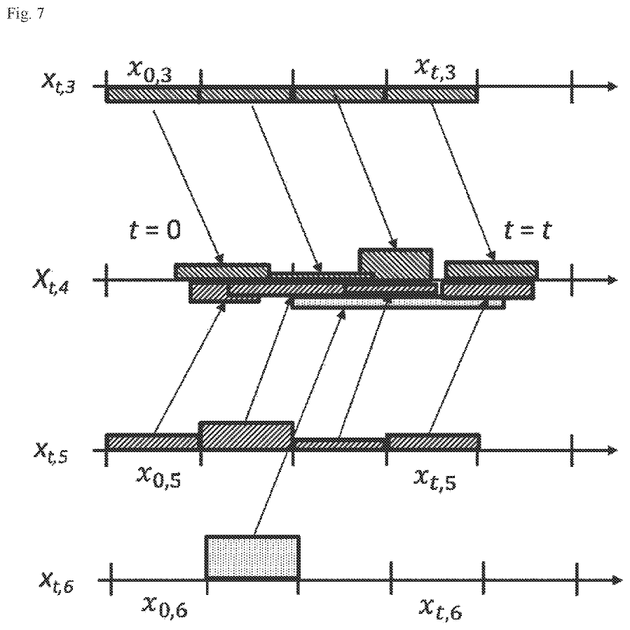

FIG. 7 is a diagram illustrating, the calculation of the weights λ. FIG. 7 illustrates observation values x_{t,3}, x_{t,5}, and x_{t,6} of the number of people in the X direction at the observation points 3, 5 and 6 and estimation values X_{t,4} of the number of people in the X direction at the observation point 4. The area of each rectangle illustrated in FIG. 7 indicates the number of people and indicates that the number of people increases as the area increases.

It is conceivable that an estimation value X_{t,4} of the number of people getting on the vehicle at time t, that is, the number of people in the X direction at the observation point 4, is the sum of the numbers of people passing in each direction at the observation points 3, 5, and 6 adjacent to the observation point 4. However, the travel time from each of the observation points 3, 5 and 6 to the observation point 4 varies from person to person. For example, an observation value x_{0,3} at the observation point 3 at time t=0 is not equal to an estimation value X_{0,4} at the observation point 4 and some of the people included in the observation value x_{0,3} can be included in an estimation value X_{1,4} at the next time t=1. Therefore, in the present embodiment, weights λ are added to the numbers of people in time periods. The weights λ are each a value of 0 or more and 1 or less.

In other words, not all people who have passed through the observation point 3, which is a gateline, in a time period got on a train at the same time and some people get on a train that arrives next. Rectangles at the heads and tails of arrows between the observation values x_{t,3}, x_{t,5}, and x_{t,6} of the number of people in the X direction and the estimation values x_{t,4} of the number of people in the X direction at the observation point 4 are equal in area, but different in shape. The widths of the rectangles indicating the estimation values X_{t,4}, that is, the times taken to get on a train, are different from each other for the walking speed or reasons such as skipping an arriving train and getting on the next train. Terms taking into account such delays of people or the like are the weights λ.

The total number of people who have passed through gatelines and the total number of people who have gotten on trains are equal when trains at the station involve only one direction. The reason for this is that people never disappear. A person who passes through a gateline in a certain time period will sooner or later get on a train, such that the sum of weights λ of the number of passing people x_{0,3} in the X direction at the observation point 3 at time t=0 for all time periods is 1. All time periods correspond, for example, to a range of time T counted from time t=0. The time from time t=0 to the elapse of time T is divided into a plurality of time periods and weights λ of 1 or less are assigned to the time periods. When the average time for a person to walk on the road network from a gateline to a train (platform) is, for example, 2/T, the weight λ of a time period including that time is the maximum. The weight λ of each time period can be determined based on a normal distribution having a peak at the time point of 2/T.

Subsequent to step S102, the CPU 11 uses the weights λ calculated in step S102, the observation values at the second observation points, and data regarding a people count observed at the first observation point where the number of people is not measured to estimate the number of people passing in each direction at the first observation point (step S103).

In the present embodiment, the CPU 11 uses weight data of the vehicle as data regarding a people count observed at the first observation point where the number of people is not measured when estimating the number of people passing in each direction at the first observation point. A weight difference Δw of a train between time t and time t+1 is a measurement value. The CPU 11 can acquire weight data of the train at time t and time t+1 and obtain the weight difference Δw as in the following equation (1). Δw is an example of an actual measurement value of a people count change derived from data regarding a people count observed at the first observation point.

### [Math. 1]

Δw=Wₜ₊₁−Wₜ (1)

Also, the weight difference of the vehicle is a weight difference caused by people getting on and off The CPU 11 can obtain an estimated weight difference ΔW of the vehicle as in the following equation (2) using estimation values X_{t,4} and Y_{t,4} of the movement of people at the observation point 4 and an average weight of people ^{—}w.

### [Math. 2]

ΔW=(X_{t,4}−Y_{t,4})w̅ (2)

ΔW is an example of an estimation value of a people count change at the first observation point derived from an estimation value of the number of people passing in each direction at the first observation point. The CPU 11 reflects the weights λ calculated in step S102 in the observation values at the observation points 3, 5 and 6 which are the second observation points to calculate estimation values X_{t,4} and Y_{t,4} of the movement of people at the observation point 4. The CPU 11 calculates the estimation values X_{t,4} by the following equation (3).

$$\begin{matrix}[ Math . 3 ] & \\ \begin{matrix}{X}_{t , 4} = \{ {λ}_{t - T , 3} {x}_{t - T , 3} + {λ}_{t - T + 1 , 3} {x}_{t - T + 1 , 3} + … + {λ}_{t , 3} {x}_{t , 3} \} + \\ \{ {λ}_{t - T , 5} {x}_{t - T , 5} + … + {λ}_{t , 5} {x}_{t , 5} \} + \\ \{ {λ}_{t - T , 6} {x}_{t - T , 6} + … + {λ}_{t , 6} {x}_{t , 6} \} \\ = {\sum }_{t = t - T}^{t} ( {λ}_{t , 3} {x}_{t , 3} + {λ}_{t , 5} {x}_{t , 5} + {λ}_{t , 6} {x}_{t , 6} )\end{matrix} & ( 3 )\end{matrix}$$

Similarly, the CPU 11 calculates the estimation values Y_{t,4} by the following equation (4).

$$\begin{matrix}[ Math . 4 ] & \\ {Y}_{t , 4} = {\sum }_{t = t}^{t + T} ( {y}_{t , 5} + {y}_{t , 6} + {y}_{t , 3} ) & ( 4 )\end{matrix}$$

λ_{t,m} and \hat{ }λ_{t,m} in equations (3) and (4) may be set as initial values with an inclination such that λ_{t,m} and \hat{ }λ_{t,m} of a time period closer to a time period t to be estimated are larger and weights λ_{t,m} and \hat{ }λ_{t,m} of a time period more distant from the time period t to be estimated are smaller. The change in weight at this time may be a linear function or may conform to a normal distribution.

Subsequent to step S103, the CPU 11 determines whether or not the calculated estimation values X_{t,4} and Y_{t,4} are consistent (step S104). Upon determining that the estimation values X_{t,4} and Y_{t,4} are inconsistent (No in step S104), the CPU 1 returns to step S102 and recalculates the weights λ. On the other hand, upon determining that the estimation values X_{t,4} and Y_{t,4} are consistent (Yes in step S104), the CPU 11 outputs the estimation values X_{t,4} and Y_{t,4}. The CPU 11 may cause the display unit 16 to display the estimation values X_{t,4} and Y_{t,4} or information including the estimation values X_{t,4} and Y_{t,4} or may send the same to another device through the communication interface 17.

Specifically, the CPU 11 substitutes the estimation values X_{t,4} and Y_{t,4} calculated by equations (3) and (4) into equation (2) and determines whether or not the weights λ_{t,m} and \hat{ }λ_{t,m} are consistent based on whether or not the value of ΔW and the value of Δw greatly deviate from each other.

If the difference between the value of ΔW and the value of Δw is larger than a predetermined amount, the CPU 11 determines that the estimation values X_{t,4} and Y_{t,4} are inconsistent and adjusts the values of the weights λ_{t,m} and \hat{ }_{t,m}. Specifically, the estimation values X_{t,4} and Y_{t,4} can be considered to be inconsistent when the weight difference Δw of the vehicle obtained from the observation values is smaller than the estimated weight difference ΔW of the vehicle obtained from the estimation values X_{t,4} and Y_{t,4}. That is, it can be considered that Δw is smaller than ΔW because the CPU 11 estimates that the difference between the number of people getting on the train and the number of people getting off the train is larger than the actual difference. For example, it can be considered that Δw is smaller than ΔW because the CPU 11 estimates the number of people getting on the train larger than the actual number, the number of people getting off the train smaller than the actual number, or both. Thus, when the value of Δw and the value of ΔW deviate from each other by a predetermined amount or more, the CPU 11 adjusts the values of the weights λ_{t,m} and \hat{ }λ_{t,m} such that ΔW approaches Δw.

Further, when an estimation value Y_{t,4} at the observation point 4 is extremely smaller or larger than the sum of observation values y_{t,m} at the observation points 3, 5, and 6 (gatelines) in the next time period, the CPU 11 corrects the weights \hat{ }λ_{t,m} such that the estimation value Y_{t,4} approaches the sum of the observation values y_{t,m}. Similarly, when X_{t,4} is extremely smaller or larger than the sum of x_{t,m} at the observation points 3, 5, and 6 (gatelines) in the next time period, the CPU 11 corrects the weights λ_{t,m} such that the estimation value X_{t,4} approaches the sum of the observation values x_{t,m}.

Y_{t,m} people from a plurality of trains will head to the observation points 3, 5 and 6 from the observation point 4 if the trains arrive at the platform of the station which is the observation point 4 in quick succession. Upon comparing each estimation value Y_{t,m} with the sum of observation values y_{t,m} at the observation points 3, 5 and 6, the CPU 11 may use a schedule for trains to arrive at the observation point 4 as a table for determining which Y_{t,m} to compare with the observation values y_{t,m}. The information management unit 101 illustrated in FIG. 2 may manage information on the train schedule. The information on the train schedule may be information including the arrival or departure times of trains.

For example, it is assumed that a schedule has been set for trains to arrive at the platform of the station at the time points of t=0 and t=2. People who arrived at the observation points 3, 5 and 6 at the time point of t=2 are likely to be those who were on a train that arrived at the time point of t=0 rather than those who were on a train that arrived at the time point of t=2, considering the time required to move from the platform of the station to the gatelines. Thus, when the above schedule has been set, the CPU 11 may determine that the sum of observation values y_{t,m} is to be compared with an estimation value Y_{0,m}.

The above operation allows the people count estimation apparatus 10 according to the present embodiment to handle data that is not direct people count data but relates to the number of people, such as the vehicle weight difference of a train between the time of arrival of the train and the time of departure, as data on the number of people passing in each direction. As a result, the people count estimation apparatus 10 according to the present embodiment can improve the estimation accuracy of data on the number of people passing in each direction while increasing the number of pieces of observation data used in human flow simulations without increasing the number of observation devices.

The people count estimation apparatus 10 may use information on the weight difference of an elevator installed in a building, as well as the vehicle weight difference of a train, as data that is not direct people count data but relates to the number of people. The people count estimation apparatus 10 can estimate the number of people entering the building and the number of people leaving the building by using the information on the weight difference of the elevator together with an actual measurement value obtained from an observation point such as the entrance of the building.

Further, the people count estimation process executed by the CPU reading software (program) in each of the above embodiments may be executed by various processors other than the CPU. Examples of such various processors include a programmable logic device (PLD) whose circuit configuration can be changed after manufacturing such as a field-programmable gateline array (FPGA) and a dedicated electric circuit which is a processor having a circuit configuration specially designed to execute specific processing such as an application specific integrated circuit (ASIC). The people count estimation process may be executed by one of these various processors or may be executed by a combination of two or more processors of the same type or different types (such as, for example, a plurality of FPGAs or a combination of a CPU and an FPGA). A hardware structure of these various processors is, more specifically, an electric circuit that combines circuit elements such as semiconductor elements.

Each of the above embodiments has been described with reference to a mode in which the people count estimation program is stored (installed) in the storage 14 in advance. However, the disclosed technology is not limited to this. Programs may be provided in a form stored in a non-transitory storage medium such as a compact disc read only memory (CD-ROM), a digital versatile disc ROM (DVD-ROM), or a universal serial bus (USB) memory. Programs may also be in a form downloaded from an external device via a network.

Regarding the above embodiments, the following supplements will further be disclosed.

### (Supplement 1)

A people count estimation apparatus includes:
a memory; and
at least one processor connected to the memory,
wherein the processor is configured to:
at least manage road network data which is spatial information data regarding a road network formed to include a plurality of observation points and a road connecting the observation points, an observation point list which is a list of the observation points, and the numbers of people passing per unit time at the observation points in each direction of the road
identify, from the observation point list, a first observation point where the number of people passing in each direction is not measured among the plurality of observation points, identify a second observation point where the number of people passing in each direction is measurable and which is connected to the first observation point by the road among the plurality of observation points, and calculate a weight that an observation value per time period at the second observation point contributes to the number of people passing in each direction at the first observation point; and
estimate the number of people passing in each direction at the first observation point using the weight, the observation value al the second observation point, and data regarding a people count observed at the first observation point.

### (Supplement 2)

A non-transitory storage medium storing a program that can be executed by a computer to perform a people count estimation process including:
at least managing road network data which is spatial information data regarding a road network formed to include a plurality of observation points and a road connecting the observation points,
an observation point list which is a list of the observation points, and the numbers of people passing per unit time at the observation points in each direction of the road;
identifying, from the observation point list, a first observation point where the number of people passing in each direction is not measured among the plurality of observation points, identifying a second observation point where the number of people passing in each direction is measurable and which is connected to the first observation point by the road among the plurality of observation points, and calculating a weight that an observation value per time period at the second observation point contributes to the number of people passing in each direction at the first observation point; and
estimating the number of people passing in each direction at the first observation point using the weight, the observation value at the second observation point, and data regarding a people count observed at the first observation point.

### REFERENCE SIGNS LIST

10 People count estimation apparatus
101 Information management unit
102 Coefficient calculation unit
103 Estimation unit

1. A people count estimation apparatus configured to:
manage, at least, road network data which is spatial information data regarding a road network formed to include a plurality of observation points and a road connecting the plurality of observation points, an observation point list which is a list of the plurality of observation points, and the number of people passing per unit time at the plurality of observation points per direction of the road;
identify, from the observation point list, a first observation point where the number of people passing in each direction is not measured among the plurality of observation points, identify a second observation point where the number of people passing in each direction is measurable and which is connected to the first observation point by the road among the plurality of observation points, and calculate a weight that an observation value per time period at the second observation point contributes to the number of people passing in each direction at the first observation point; and
estimate the number of people passing in each direction at the first observation point, using the weight, the observation value at the second observation point, and data regarding a people count observed at the first observation point.

2. The people count estimation apparatus according to claim 1, further configured to:
determine a consistency of the number of people passing in each direction at the first observation point.

3. The people count estimation apparatus according to claim 2, further configured to:
determine the consistency of the number of passing people based on whether a difference between an estimation value of a people count change at the first observation point derived from an estimation value of the number of people passing in each direction at the first observation point and an actual measurement value of a people count change derived from data regarding the people count observed at the first observation point is larger than a predetermined amount.

4. The people count estimation apparatus according to claim 2, further configured to:
recalculate the weights based on a result of determination of the consistency of the number of people.

5. The people count estimation apparatus according to claim 1, wherein the data regarding the people count observed at the first observation point is weight data of a vehicle on which people ride, the weight data being obtained by measuring every unit time.

6. The people count estimation apparatus according to claim 5, wherein the vehicle is a railway vehicle.

7. A people count estimation method for a computer executing processing comprising:
managing, at least, road network data which is spatial information data regarding a road network formed to include a plurality of observation points and a road connecting the plurality of observation points, an observation point list which is a list of the plurality of observation points, and the numbers of people passing per unit time at the plurality of observation points per direction of the road;
identifying, from the observation point list, a first observation point where the number of people passing in each direction is not measured among the plurality of observation points, identifying a second observation point where the number of people passing in each direction is measurable and which is connected to the first observation point by the road among the plurality of observation points, and calculating a weight that an observation value per time period at the second observation point contributes to the number of people passing in each direction at the first observation point; and
estimating the number of people passing in each direction at the first observation point using the weight, the observation value at the second observation point, and data regarding a people count observed at the first observation point.

8. A non-transitory computer-readable medium having computer-readable instructions stored thereon, which, when executed, cause a computer including a memory and a processor to execute a set of operations, comprising:
managing, at least, road network data which is spatial information data regarding a road network formed to include a plurality of observation points and a road connecting the plurality of observation points, an observation point list which is a list of the plurality of observation points, and the numbers of people passing per unit time at the plurality of observation points per direction of the road;
identifying, from the observation point list, a first observation point where the number of people passing in each direction is not measured among the plurality of observation points, identifying a second observation point where the number of people passing in each direction is measurable and which is connected to the first observation point by the road among the plurality of observation points, and calculating a weight that an observation value per time period at the second observation point contributes to the number of people passing in each direction at the first observation point; and
estimating the number of people passing in each direction at the first observation point using the weight, the observation value at the second observation point, and data regarding a people count observed at the first observation point.

9. The people count estimation apparatus of claim 1, further configured to at least one of:
cause display of a result of estimation of the number of people; or
transmit the result to a remote computing device.

10. The people count estimation method according to claim 7, further comprising:
determining a consistency of the number of people passing in each direction at the first observation point.

11. The people count estimation method according to claim 10, wherein the consistency of the number of people is determined based on whether a difference between an estimation value of a people count change at the first observation point derived from an estimation value of the number of people passing in each direction at the first observation point and an actual measurement value of a people count change derived from data regarding the people count observed at the first observation point is larger than a predetermined amount.

12. The people count estimation method according to claim 10, further comprising:
recalculating the weights based on a result of determination of the consistency of the number of people.

13. The people count estimation method according to claim 7, wherein the data regarding the people count observed at the first observation point is weight data of a vehicle on which people ride, the weight data being obtained by measuring every unit time.

14. The people count estimation method according to claim 13, wherein the vehicle is a railway vehicle.

15. The people count estimation method according to claim 7, further comprising at least one of:
causing display of a result of estimation of the number of people; or
transmitting the result to a remote computing device.

16. The non-transitory computer-readable medium according to claim 8, wherein the set of operations further comprises:
determining a consistency of the number of people passing in each direction at the first observation point.

17. The non-transitory computer-readable medium according to claim 16, wherein the consistency of the number of people is determined based on whether a difference between an estimation value of a people count change at the first observation point derived from an estimation value of the number of people passing in each direction at the first observation point and an actual measurement value of a people count change derived from data regarding the people count observed at the first observation point is larger than a predetermined amount.

18. The non-transitory computer-readable medium according to claim 16, wherein the set of operations further comprises:
recalculating the weights based on a result of determination of the consistency of the number of people.

19. The non-transitory computer-readable medium according to claim 8, wherein the data regarding the people count observed at the first observation point is weight data of a vehicle on which people ride, the weight data being obtained by measuring every unit time.

20. The non-transitory computer-readable medium according to claim 19, wherein the vehicle is a railway vehicle.
